(19) United States
(12) Patent Application Publication
(10) Pub. No.: US 2022/0331741 A1
(43) Pub. Date: Oct. 20, 2022

(54) FILTRATION MEMBRANE ASSEMBLY AND METHOD OF CLEANING THE SAME

(71) Applicant: Hydranautics, Oceanside, CA (US)

(72) Inventor: Keith ANDES, Hillarys (AU)

(21) Appl. No.: 17/641,114

(22) PCT Filed: Jan. 14, 2020
(86) PCT No.: PCT/US20/13456

§ 371 Date: Mar. 8, 2022

Related U.S. Application Data
(60) Provisional application No. 62/912,450, filed on Oct. 8, 2019.

(51) Int. Cl. B01D 65/02; B01D 61/02; B01D 63/10; B01D 63/12

(52) U.S. Cl. CPC B01D 65/02; B01D 61/025; B01D 63/10; B01D 63/12; B01D 2313/13; B01D 2313/21; B01D 2319/022; B01D 2321/04

(57) ABSTRACT

An assembly for treating a liquid is provided. The assembly includes a pressure vessel having first and second ends provided with respective first and second endcaps, a membrane element positioned within the pressure vessel, an adapter coupling the first endcap with a first end of the membrane element, a first set of shims positioned between the first endcap and the first adapter, a first thrust collar positioned between the first endcap and the first end of the membrane element, a second thrust collar positioned between the second endcap and a second end of the membrane element, and a second set of shims positioned between the first thrust collar and the first end of the membrane element. An overall thickness of the second set of shims is the same as an overall thickness of the first set of shims.

### CROSS-REFERENCE TO RELATED APPLICATIONS

This application claims priority from U.S. Provisional Patent Application No. 62/912,450, filed Oct. 8, 2019, the entire disclosure of which is herein incorporated by reference.

### BACKGROUND OF THE INVENTION

The present invention is directed generally to a filtration membrane assembly, and more particularly a reverse osmosis membrane assembly, and a method of cleaning the filtration membrane assembly.

Various types of filtration processes utilize a permeable or semipermeable membrane to treat liquids. Examples of such filtration processes include, but are not limited to, nanofiltration, ultrafiltration, microfiltration and reverse osmosis. While the discussion herein is focused primarily on reverse osmosis systems, the present invention is equally applicable to any known filtration processes and assemblies.

Reverse osmosis (RO) is a water purification process that utilizes a partially permeable membrane element to treat water containing ions, unwanted molecules and larger particles, such as dissolved salts, organic compounds, colloids and microorganisms. RO treatment is carried out by flowing a water stream across the feed side of a RO membrane element and applying pressure of a magnitude higher than the osmotic pressure of the feed solution on the feed side of the RO membrane assembly. Water molecules pass through the RO membrane element under the driving force of this increased pressure to remove dissolved and suspended chemical and biological species from the feed water. The resulting treated water is then withdrawn from the permeate side of the RO membrane assembly. Dissolved salts, organic compounds, colloids, microorganisms and any other matter suspended in the water are retained on the feed side of the RO membrane assembly, and are known as concentrate or reject.

A typical RO membrane assembly consists of a pressure vessel containing one or more RO membrane elements (e.g., usually anywhere from 1 to 8 RO membrane elements). The pressure vessel has a feed port, a concentrate port and one or more permeate ports. Raw feed water is introduced into the pressure vessel via the feed port, and travels through the RO membrane elements beginning with a lead membrane element at the upstream end of the pressure vessel and ending with a tail end membrane element at the downstream end of the pressure vessel. The pressure vessel typically includes a thrust ring at the downstream end (i.e., in contact with the tail end RO membrane element) to support the RO membrane elements and prevent them from telescoping due to the force of the pressurized water flowing through the pressure vessel in the forward direction (i.e., from the upstream end toward the downstream end).

The RO membrane elements, however, accumulate foulants over time and, thus, need to be periodically cleaned. Clean-in-Place (CIP) systems and methods have been designed to clean the RO membrane assemblies by flowing a cleaning solution or a flushing solution through the membrane elements in the forward direction. The forward direction flow pattern is the same way that the RO membrane assembly operates under normal operating conditions. The RO membrane elements are supported by the downstream end thrust ring, and thus do not telescope or move as a result of the forward direction flow of cleaning solution.

However, certain types of foulants, such as heavy biological fouling, colloidal matter and particulate fouling, tend to accumulate at the feed end of the lead (or front) membrane element. In such situations, forward direction flushing or cleaning is not very effective at removing these foulants that have accumulated at the feed end of the lead RO membrane element, because it is difficult to break up the foulants at the lead RO membrane element by forward direction cleaning/flushing. Further, in such situations, forward direction cleaning can result in the foulant accumulated at the lead RO membrane element being carried downstream by the cleaning solution to all of the other RO membrane elements contained in the pressure vessel.

However, for such cases, manufacturers have generally dissuaded operators from utilizing reverse direction cleaning methods (i.e., flushing or cleaning in a reverse direction). This is because, in contrast to the support provided at the downstream end of the pressure vessel by the thrust ring, no support is typically provided for the RO membrane elements at the feed (or front or upstream) end. Therefore, during reverse direction cleaning, the force of the cleaning solution being flushed through the pressure vessel in the reverse direction (i.e., in a direction opposite to the flow pattern of normal operating conditions) would cause the RO membrane elements to move and/or telescope, thereby causing damage to the RO membrane elements.

Therefore, it would be desirable to provide a support mechanism for a filtration membrane assembly, particularly a RO membrane assembly, which is suitable for enabling reverse direction cleaning of the assembly's membrane elements, particularly in cases where foulants have accumulated at or on the lead membrane element.

### BRIEF SUMMARY OF THE INVENTION

Briefly stated, one aspect of the present invention is directed to an assembly for treating a liquid. The assembly comprises one or more pressure vessels, each pressure vessel having a first end provided with a first endcap, an opposing second end provided with a second endcap, and a sidewall extending between the first and second ends; at least one membrane element positioned within each pressure vessel between the first and second ends, each membrane element having a first end and an opposing second end; a first adapter coupling the first endcap of each pressure vessel with the first end of the at least one membrane element; a first set of shims positioned between a distal end of the first endcap of each pressure vessel and the first adapter; a first thrust collar positioned between the first endcap of each pressure vessel and the first end of the at least one membrane element, the first thrust collar having a first open end, an opposing second open end and a sidewall extending from the first open end to the second open end, the second open end abutting the first endcap; a second thrust collar positioned between the second endcap of each pressure vessel and the second end of the at least one membrane element, the second thrust collar having a first open end, an opposing second open end and a sidewall from the first open end to the second open end, the second open end abutting the second endcap; and a second set of shims positioned between the first open end of the first thrust collar and the first end of the at least one membrane element. An overall thickness of the second set of shims is the same as an overall thickness of the first set of shims.

In another aspect, the present invention relates to a kit for a reverse osmosis assembly. The reverse osmosis assembly comprises a pressure vessel having a first end provided with a first endcap and an opposing second end provided with a second endcap, at least one membrane element positioned within the pressure vessel between the first and second ends, a first adapter coupling the first endcap with a first end of the at least one membrane element, a thrust collar positioned between the second endcap and a second end of the at least one membrane element, and a set of shims positioned between the first endcap and the first end of the at least one membrane element. The kit comprises an additional set of shims configured to be positioned between a distal end of the first endcap and the first adapter of the reverse osmosis assembly, and an additional thrust collar configured to be positioned between the first endcap and the first end of the at least one membrane element of the reverse osmosis assembly. The additional set of shims have an overall thickness preselected to be the same as an overall thickness of the set of shims of the reverse osmosis assembly. The set of shims of the reverse osmosis assembly are positioned between the additional thrust collar and the first end of the at least one membrane element.

Another aspect of the present invention is directed to a method of operating a reverse osmosis assembly. The reverse osmosis assembly comprises a pressure vessel having a first end provided with a first endcap and an opposing second end provided with a second endcap, a first port proximate the first end of the pressure vessel and a second port proximate the second end of the pressure vessel, at least one membrane element positioned within the pressure vessel between the first and second ends, a first adapter coupling the first endcap with a first end of the at least one membrane element, a first thrust collar positioned between the first endcap and the first end of the at least one membrane element, a second thrust collar positioned between the second endcap and a second end of the at least one membrane element, a first set of shims positioned between the first thrust collar and the first end of the at least one membrane element, and a second set of shims positioned between a distal end of the first endcap and the first adapter, an overall thickness of the second set of shims being the same as an overall thickness of the first set of shims. The method comprises treating a first liquid by introducing the first liquid into the pressure vessel via the first port under pressure, such that the first liquid travels through the at least one membrane element in a first direction from the first end of the at least one membrane element toward the second end of the at least one membrane element; and upon detection of foulant accumulated on the at least one membrane element, cleaning the assembly by introducing a second liquid into the pressure vessel via the second port, such that the second liquid travels through the at least one membrane element in a second direction from the second end of the at least one membrane element toward the first end of the at least one membrane element.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a front elevation view of a reverse osmosis assembly according to an embodiment of the present invention;

FIG. 2 is a cross-sectional view of the reverse osmosis assembly shown in FIG. 1 taken along line A-A of FIG. 1;

FIG. 3 is an enlarged cross-sectional view of a portion of the reverse osmosis assembly of FIG. 1 taken along line A-A of FIG. 1;

FIG. 4 is an enlarged, partial cross-sectional, perspective view of a portion of the reverse assembly of FIG. 1, wherein portions of the assembly are omitted for clarity;

FIG. 5 is an enlarged view of a portion of the reverse osmosis assembly of FIG. 1 about area B of FIG. 4;

FIG. 6 is an enlarged view of a portion of the reverse osmosis assembly of FIG. 1 about area C of FIG. 4;

FIG. 7 is an exploded, perspective view of certain components of a portion of the reverse osmosis assembly of FIG. 1;

FIG. 8 depicts a first operational configuration of the reverse osmosis assembly of FIG. 1 for treatment of a liquid; and

FIG. 9 depicts a second operational configuration of the reverse osmosis assembly of FIG. 1 for cleaning of the assembly.

### DETAILED DESCRIPTION OF THE INVENTION

Certain terminology is used in the following description for convenience only and is not limiting. The words “lower,” “upper,” “bottom” and “top” designate directions in the drawings to which reference is made. The words “inwardly” and “outwardly” refer to directions toward and away from, respectively, the geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

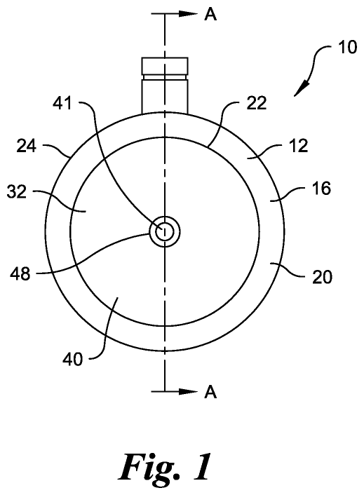

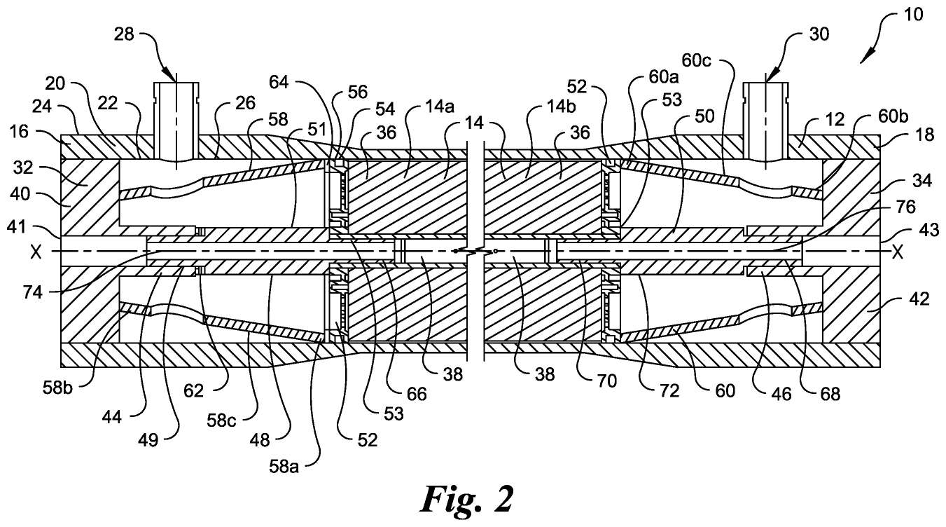

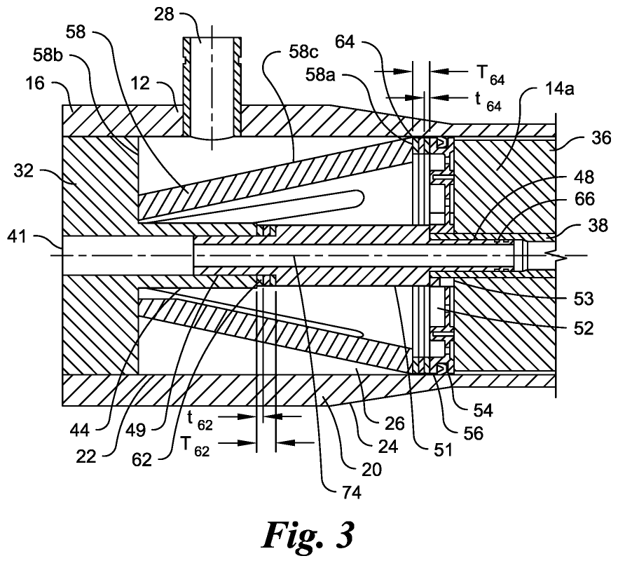

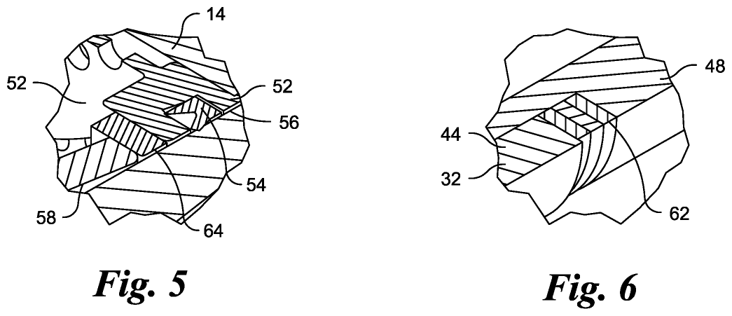

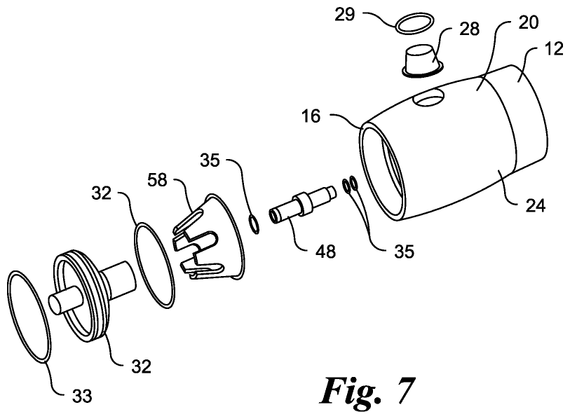

Referring to the drawings in detail, wherein like numerals indicate like elements throughout the several views, FIGS. 1-7 show a RO membrane assembly, generally designated 10, in accordance with a first embodiment of the present invention. Piping (e.g., supply and discharge lines), pretreatment systems, pumps, containment vessels, valves, socket pieces, connecting branches and other components and equipment (not shown) are preferably built around and/or operatively connected to the assembly 10 in a known manner to form a complete RO system.

The assembly 10 comprises a housing 12 surrounding one or more RO membrane elements 14. The housing 12 is preferably designed and configured as a pressure vessel 12 which allows liquid to flow through the RO membrane elements 14. In one embodiment, the pressure vessel 12 has a generally tubular shape. However, it will be understood by those skilled in the art that the pressure vessel 12 may have an alternative shape, such as rectangular, conical, frustoconical, and the like. The RO membrane elements 14 are preferably interconnected and arranged in any manner so as to achieve the desired end configuration.

The pressure vessel 12 has a first end 16 and an opposing second end 18, a sidewall 20 extending along a longitudinal axis X between the first and second ends 16, 18, a first endcap 32 closing off the first end 16, and a second endcap 34 closing off the second end 18. The sidewall 20 is preferably a tubular sidewall. The sidewall 20 has an interior surface 22 and an exterior surface 24, with the interior surface 22 defining an inner cavity 26 of the pressure vessel 12 which is configured to house various components of the assembly 10, including the RO membrane elements 14. In a preferred embodiment, an O-ring 33 or other type of sealing mechanism is provided at at least one of, and preferably both of, the first and second ends 16, 18 of the pressure vessel 12 to provide a fluid tight seal between the sidewall 20 and the first and/or second endcaps 32, 34. The first and second endcaps 32, 34 may be secured to the pressure vessel 12 by any known mechanism and method, such as by segmented rings or clam-shell locks.

A first port 28 is provided at the first end 16 of the pressure vessel 12 and a second port 30 is provided at the second end 18 of the pressure vessel 12. Each of the first and second ports 28, 30 preferably extends through the sidewall 20 of the pressure vessel 12, such that the ports 28, 30 are in communication with the inner cavity 26 of the pressure vessel 12 and more particularly with the RO membrane elements 14 positioned therein. In a preferred embodiment, an O-ring 29 or other type of sealing mechanism is provided to ensure a fluid tight seal at at least one of, and preferably both of, the first and/or second ports 28, 30. It will be understood that the first and second ports 28, 30 could instead be formed in another portion of the pressure vessel 12, such as in the respective endcaps 32, 34.

In one embodiment, the first port 28 is connected to a feed liquid source (not shown), such as a tank or vessel containing raw water, waste liquids (e.g., waste cleaning solution or flushing solution) or other liquid to be treated. In one embodiment, the second port 30 is connected to a tank or vessel (not shown) configured to store concentrate from the treated feed liquid. In another embodiment, the second port 30 is connected to a cleaning or flushing liquid source (not shown), such as a tank or vessel containing a liquid, such as water, permeate, a flushing solution, a cleaning solution and the like, which is to be flushed through the assembly 10 for removal of any accumulated foulant.

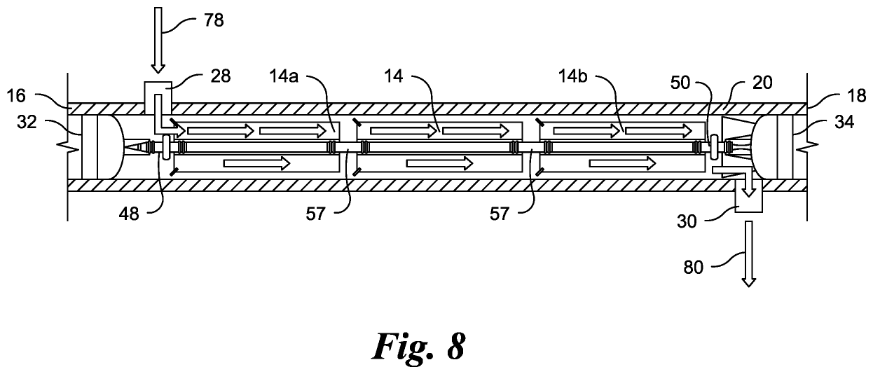

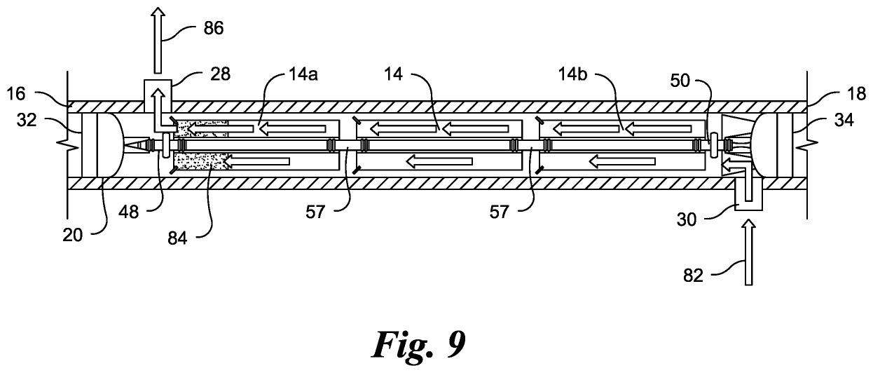

The assembly 10 preferably has and/or is operable in a first configuration, which is a normal forward direction reverse osmosis treatment process, as shown in FIG. 8, and a second configuration which is a reverse direction operation, as shown in FIG. 9.

In the first operable configuration, as is described in more detail hereinafter, a feed liquid, such as raw water, is introduced into the pressure vessel 12 through the first port 28 (i.e., the first port is a feed port) and then passes through the at least one RO membrane element 14 housed in the pressure vessel 12.

In one embodiment, the pressure vessel 12 includes a plurality of interconnected RO membrane elements 14, and more particularly a series of interconnected RO membrane elements 14, positioned between the first and second ends 16, 18 of the pressure vessel 12. In such an embodiment, in the first operable configuration, the feed liquid which is introduced into the pressure vessel 12 through the first port 28 passes through the series of interconnected RO membrane elements 14, beginning with the foremost RO membrane element 14 at the first end 16 of the pressure vessel 12 and ending with the last RO membrane element 14 proximate the second end 18 of the pressure vessel 12. As such, the foremost upstream RO membrane element 14 (i.e., the RO membrane element 14 in the series which is situated most proximate the first end 16, and more particularly the first endcap 32, of the pressure vessel 12) is hereinafter referred to as a first or lead RO membrane element 14a, while the RO membrane element 14 in the series situated most proximate the second end 18, and more particularly the second endcap 34, of the pressure vessel 12, and farthest away from the first end 16 and the leading RO membrane element 14, is hereinafter referred to as a last RO membrane element 14b.

The pressure vessel 12 is preferably made from a strong, rigid material capable of withstanding high pressures present in RO systems, such as fiber reinforced plastic, fiber reinforced polyester, glass reinforced polyester, or glass reinforced epoxy (GRE). Most preferably, pressure vessel 12 is manufactured by winding resin coated glass/carbon fibers around a mandrel to produce a hard-shell pressure vessel 12. The pressure vessel 12 is preferably designed to operate at pressures up to 1200 PSI. The dimensions of the pressure vessel 12 will vary based upon the number of RO membrane elements 14 contained therein and the dimensions of the RO membrane elements 14 contained therein. For example, a pressure vessel 12 which houses one RO membrane element 14 preferably has a length of approximately 1½ meters, a pressure vessel 12 which houses two RO membrane elements 14 preferably has a length of approximately 2½ meters, and so forth. In addition, where the RO membrane elements 14 have an outer diameter of approximately 8 inches, the pressure vessel 12 has a diameter of approximately 9 to 10 inches.

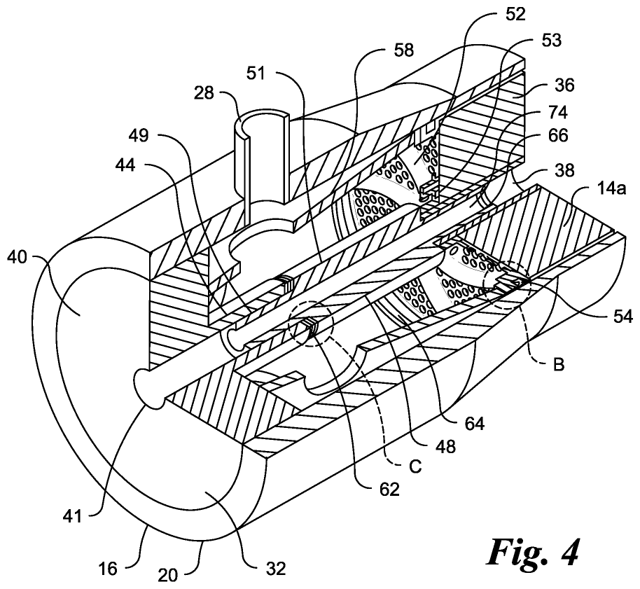

Each RO membrane element 14 is preferably a spiral wound membrane element. Referring to FIG. 4, each spiral wound RO membrane element 14 comprises a cylindrically wound body 36 comprising a separation membrane, a feed-side passage/spacer material and a permeation-side passage/spacer material spirally wound around a perforated core tube 38 in a laminated state. Permeate is collected in the core tube 38 of each RO membrane element 14.

It will be understood by those skilled in the art that the RO membrane elements 14 may comprise any commercially available membranes. The following discussion relates to a preferred embodiment of the RO membrane elements 14.

The separation membrane comprises a porous support and skin layer successively laminated on a non-woven fabric layer. Material of the non-woven fabric layer is not particularly limited. Examples of the material of the non-woven fabric layer include polyesters and polyolefins. The porous support is microporous and may be formed of, for example, polysulfones, polyaryl sulfones (such as polyether sulfone), polyamides and polyvinylidene fluoride. A porous layer comprising polysulfones or polyaryl sulfones is preferable from the standpoint of chemical, mechanical and thermal stabilities. Examples of the material that may be used to form the skin layer include polyethylene, polypropylene, polyethylene terephthalate, nylon, polyamide, polyacrylonitrile, polyvinyl alcohol, polymethyl methacrylate, polysulfone, polyether sulfone, polyimide, and ethylene-vinyl alcohol copolymers.

Examples of the feed-side passage material that can be used include a net material, a mesh material, a grooved sheet and a wave sheet. Examples of the permeation-side passage material that can be used include a net material, a fabric material, a mesh material, a grooved sheet and a wave sheet. The perforated core tube 38 is not particularly limited so long as it has openings around the tube.

To prevent the feed-side liquid and the permeation-side liquid from being mixed together, a sealing resin is applied to the edges of the separation membrane facing through the permeation-side passage material from the porous support side to impregnate the sealing resin at least up to the vicinity of the skin layer, thereby sealing the edges.

The RO membrane elements 14 may have any suitable dimensions. For instance, in one embodiment, the RO membrane elements 14 have an outer diameter of approximately 8 inches. However, it will be understood that the dimensions of the RO membrane elements 14 may be selected so as to suit the desired end application. The outer diameter of each RO membrane element 14 must, however, be at least slightly smaller than the inner diameter of the pressure vessel 12 so as to be able to be contained therein.

A supporting member 52, known as an anti-telescoping device or ATD, is provided at both ends of each RO membrane element 14 to prevent unraveling and extension of the element 14 during operation. When multiple RO membrane elements 14 are present in the assembly 10, the ATD 52 provided at one end of a first RO membrane element 14 will abut the ATD 52 provided at one end of an adjacent and second RO membrane element 14, and so forth. Each ATD 52 has a generally cylindrical shape and an outer diameter matching that of the associated RO membrane element 14 (e.g., approximately 8 inches), and a central opening 53 through which the core tube 38 of the respective element 14 interfaces and connects with an interconnecting adapter 57 (see FIGS. 8-9) or endcap adapter 48, 50, as described in more detail hereinafter.

Each RO membrane element 14 preferably includes a brine seal 54 which provides a seal between the outer surface of each element 14 and the interior surface 22 of the pressure vessel 12, thereby ensuring that the feed water flows through the RO membrane elements 14 rather than around the outside of the elements 14. The brine seal 54 is preferably placed in a peripheral groove 56 in one of the ATDs 52 of each RO membrane element 14. More preferably, the brine seal 54 is positioned in the peripheral groove 56 formed in the ATD 52 at the leading or feed water end of each RO membrane element 14.

In a configuration of the assembly 10 comprising two or more RO membrane elements 14, the RO membrane elements 14 preferably include one or more interconnectors 57 (shown only schematically in FIGS. 8-9) between each adjacent element 14. Each interconnector 57 connects and seals the core tubes 38 of adjacent RO membrane elements 14 with each other. The interconnectors 57 may have one or two O-rings or other sealing mechanisms on one or both ends. Such interconnectors are also known as interconnecting adapters.

The first endcap 32 has a main body 40 configured to be received within the first end 16 of the pressure vessel 12, and a first conduit 44 extending through the main body 40. Similarly, the second endcap 34 has a main body 42 configured to be received within the second end 18 of the pressure vessel 12, and a second conduit 46 extending through the main body 42. In a preferred embodiment, the first and second conduits 44, 46 extend through a geometric center of the respective main bodies 40, 42. In a preferred embodiment, the first and second conduits 44, 46 are generally tubular, but it will be understood that these conduits 44, 46 may have an alternative shape.

The shape of the main body 40, 42 of the first and second endcaps 32, 34 preferably conforms with that of the first and second ends 16, 18 of the pressure vessel 12. Further, the size of the main body 40, 42 of the first and second endcaps 32, 34 is preferably dimensioned to fit within the respective first and second ends 16, 18 of the pressure vessel 12. More particularly, the outer diameter of the main body 40, 42 of each endcap 32, 34 matches or is just slightly smaller than the inner diameter of the first and second ends 16, 18 of the pressure vessel 12, such that the first endcap 32 and second endcap 34 fit snugly within the first and second ends 16, 18, respectively, of the pressure vessel 12. The main body 40, 42 of each endcap 32, 34 includes an opening 41, 43, preferably formed at the geometric center thereof, and the respective conduit 44, 46 extends from the opening 41, 43 toward the inner cavity 26 of the pressure vessel 12. The conduits 44, 46 have an outer diameter that is smaller than that of the respective main bodies 40, 42.

The first and second openings 41, 43 are first and second permeate ports for transporting filtered liquid (i.e., permeate) out of the pressure vessel 12. More particularly, the first and second permeate ports 41, 43 are connected to the core tube 38 of the adjacent RO membrane element 14 via the respective first and second conduits 44, 46 and a respective adapter, and more particularly a respective endcap adapter 48, 50. In an embodiment where the pressure vessel 12 contains a series of interconnected RO membrane elements 14, the first permeate port 41 is connected to the core tube 38 of the first RO membrane element 14a via the first conduit 44 and a first endcap adapter 48, and the second permeate port 43 is connected to the core tube 38 of the last RO membrane element 14b via the second conduit 46 and a second endcap adapter 50.

The first endcap adapter 48 has a first end portion 49 having an outer diameter that is at least slightly smaller than the inner diameter of the first conduit 44 of the first endcap 32, a second end portion 66 having an outer diameter that is at least slightly smaller than the inner diameter of the core tube of the first RO membrane element 14a, and an intermediate or central portion 51 having an enlarged outer diameter relative to the outer diameters of the first and second end portions 49, 66. The second endcap adapter 50 has a first end portion 68 having an outer diameter that is at least slightly smaller than the inner diameter of the second conduit 46 of the second endcap 34, a second end portion 70 having an outer diameter that is at least slightly smaller than the inner diameter of the core tube of the last RO membrane element 14b, and an intermediate or central portion 72 having an enlarged outer diameter relative to the outer diameters of the first and second end portions 68, 70. As such, the first end portion 49 of the first endcap adapter 48 is configured to be received within the first conduit 44 of the first endcap 32 and the second end portion 66 of the first endcap adapter 48 is configured to be received within an end of a core tube 38 of a RO membrane element 14, while the first end portion 68 of the second endcap adapter 50 is configured to be received within the second conduit 46 of the second endcap 34 and the second end portion 70 of the second endcap adapter 50 is configured to be received with an end of a core tube 38 of a RO membrane element 14b. More particularly, the second end portion 66, 70 of the first and second endcap adapters 48, 50 extends through the opening 53 of the ATD 52 of the first and last RO membrane elements 14a, 14b, respectively, to be received within the core tube 38 thereof. The enlarged outer diameter of each intermediate portion 51, 72 generally matches the outer diameter of the first and second conduits 44, 46, respectively. Each endcap adapter 48, 50 includes a conduit 74, 76, respectively, which extends therethrough.

In a configuration wherein the assembly 10 comprises only one RO membrane element 14, (i) the first conduit 44 of the first endcap 32 is in flow communication with a first end of the core tube 38 by the first endcap adapter 48, and more particularly by the first end portion 49 of the first adapter 48 being received within the first conduit 44 of the first endcap 32 and the second end portion 66 of the first adapter 48 being received within the first end of the core tube 38; and (ii) the second conduit 46 of the second endcap 34 is in flow communication with a second end of the core tube 38 by the second endcap adapter 50, and more particularly by the first end portion 68 of the second adapter 50 being received within the second conduit 46 of the second endcap 34 and the second end portion 70 of the second adapter 50 being received within the second end of the core tube 38. As such, permeate from the RO membrane element 14 can be carried from the first end of the core tube 38 to the first permeate port 41 through the conduit 74 of the first endcap adapter 48 and the first conduit 44 of the first endcap 32, and permeate from the RO membrane element 14 can be carried from the second end of the core tube 38 to the second permeate port 43 through the conduit 76 of the second endcap adapter 50 and the second conduit 46 of the second endcap 34.

In a configuration wherein the assembly 10 comprises two or more RO membrane elements 14 (e.g., lead element 14a and last element 14b), (i) the first conduit 44 of the first endcap 32 is in flow communication with an end of the core tube 38 of the lead RO membrane element 14a by the first end portion 49 of the first adapter 48 being received within the first conduit 44 of the first endcap 32 and the second end portion 66 of the first adapter 48 being received within an end of the core tube 38 of the lead RO membrane element 14a, and (ii) the second conduit 46 of the second endcap 34 is in flow communication with an end of the core tube 38 of the last RO membrane element 14b by the first end portion 68 of the second adapter 50 being received within the second conduit 46 of the second endcap 34 and the second end portion 70 of the second adapter 50 being received within the second end of the core tube 38 of the last RO membrane element 14b.

Each endcap adapter 48, 50 therefore connects and seals the RO membrane elements 14 situated at each end 16, 18 of the pressure vessel 12 with the respective endcap 32, 34. An O-ring 35 or other sealing mechanism may be provided at the interface of the joined endcap adapter 48, 50 and endcap 32, 34.

With the first endcap 32 connected to the first endcap adapter 48, a clearance or gap often remains between the distalmost end of the first conduit 44 and the central portion 51 due to component variances. Such a gap or clearance would enable undesirable movement of the RO membrane elements 14 in the reverse direction, for example at the end of a treatment process when the high pressure is turned off and the RO membrane elements 14 snap back after having been subjected to force in the forward direction by the forced water flow. Accordingly, to prevent the undesirable movement of the RO membrane elements 14 in the reverse direction, a first set of shims 62, constituting one or more shims 62, is provided between the first endcap 32 and the first endcap adapter 48, and more particularly between the distalmost end of the first conduit 44 and the central portion 51.

Each shim 62 has a generally hollow cylindrical shape. Each shim 62 preferably has an outer diameter that matches the outer diameters of the first conduit 44 of the first endcap 32 and the central portion 51 of the first endcap adapter 48, an inner diameter that is just slightly larger than the outer diameter of the first end portion 49 of the first endcap adapter 48 so that the first end portion 49 can pass through the hollow interior of the shim 62, and a thickness t₆₂ of approximately 1/16 to ¼ inches, and more preferably approximately ⅛ inches. In a preferred embodiment, three shims 62 are provided in the space between the first endcap 32 and the first endcap adapter 48, and more particularly between the distalmost end of the first conduit 44 and the central portion 51.

A first thrust collar or thrust ring 58 is provided at the first end 16 of the pressure vessel 12 and a second thrust collar or thrust ring 60 is provided at the second end 18 of the pressure vessel 12. Each thrust collar 58, 60 has a first end 58a, 60a; an opposing second end 58b, 60b; and a sidewall 58c, 60c extending between the first and second ends 58a, 60a, 58b, 60b. The outer diameter of the first end 58a, 60a is preferably generally the same as the outer diameter of each RO membrane assembly 14. The first and second ends 58a, 58b, 60a, 60b of the first and second thrust collars 58, 60 are preferably open ends. That is, the first and second ends 58a, 58b, 60a, 60b of the first and second thrust collars 58, 60 may be devoid of a wall and completely open, or may include a wall with an opening formed therethrough.

In one embodiment, one or both of the thrust collars 58, 60 has/have a generally cylindrical cross-sectional profile, such that the sidewall 58c, 60c has a generally cylindrical shape and the diameter of the first open end 58a, 60a is the same as that of the second open end 58b, 60b.

In another embodiment, one or both of the thrust collars 58, 60 has/have a generally tapered or wedge-shaped cross-sectional profile. More particularly, the first open end 58a, 60a has a larger diameter than the diameter of the second open end 58b, 60b, and the sidewall 58c, 60c slopes or tapers from the first open end 58a, 60a toward the second open end 58b, 60b. assembly

The first open end 60a of the second thrust collar 60 abuts the ATD 52 of the last RO membrane element 14b, and the second open end 60b abuts the main body 42 of the second endcap 34. The second thrust collar 60 therefore minimizes forward movement (i.e., movement in the normal flow direction of the feed liquid from the first end 16 toward the second end 18) of the RO membrane elements 14 and relieves some of the load exerted on the second end cap adapter 50 by the pressurized feed liquid flow.

The first open end 58a of the first thrust collar 58 is proximate but spaced apart from the ATD 52 of the lead RO membrane element 14a, and the second open end 58b abuts the main body 40 of the first endcap 32. A second set of shims 64, constituted by one or more shims 64, is provided between the first thrust collar 58 and the ATD 52 at the feed end of the lead RO membrane element 14a. Similar to the shims 62 of the first set of shims 62, each shim 64 of the second set of shims 64 has a generally hollow cylindrical shape. Each shim 64 of the second set preferably has an outer diameter that matches the outer diameters of the first end 58a of the first thrust collar 58 and the ATD 52, and a thickness t₆₄ of approximately 1/16 to ¼ inches, and more preferably approximately ⅛ inches. In a preferred embodiment, three shims 64 are provided in the space between the first end 58a of the first thrust collar 58 and the ATD 52 at the feed end of the lead RO membrane element 14a. More preferably, the overall thickness T₆₂ of the first set of shims 62 is the same as the overall thickness T₆₄ of the second set of shims 64. That is, it will be understood that the number of shims 62 in the first set of shims 62 need not correspond with or match the number of shims 64 in the second set of shims 64. Rather, it is preferable that the overall thickness T₆₂ of the first set of shims 62 matches the overall thickness T₆₄ of the second set of shims 64.

The combination of the first thrust collar 58, the first set of shims 62 and the second set of shims 64 minimizes rearward movement (i.e., movement in the reverse direction from the second end 18 toward the first end 16) of the RO membrane elements 14, and relieves some of the load exerted on the first end cap adapter 48.

In one aspect, the present invention relates to a kit comprising the first thrust collar 58 and the first set of shims 62 for assembly with the remaining components of the assembly 10 as described herein. That is, in one embodiment, a preexisting reverse osmosis assembly 10 includes a pressure vessel 12 having a first end 16 provided with a first endcap 32 and an opposing second end 18 provided with a second endcap, at least one membrane element 14 (and more preferably a series of interconnected membrane elements 14) positioned between the first and second ends 16, 18 of the pressure vessel 12, a first adapter 48 coupling the first endcap 32 with a first end of the at least one membrane element 14, a thrust collar 60 positioned between the second endcap 34 and a second end of the at least one membrane element 14, and a set of shims 64 positioned between the first endcap 32 and the first end of the at least one membrane element 14, while the kit comprises an additional set of shims 62 an additional thrust collar 58 configured to be retrofitted to the preexisting assembly 10. More particularly, the additional set of shims 62 are configured to be positioned between a distal end of the first endcap 32 and the first adapter 48, and have an overall thickness T₆₂ preselected to be the same as an overall thickness T₆₄ of the set of shims 64 of the assembly 10. The additional thrust collar 58 is configured to be positioned between the first endcap 32 and the first end of the at least one membrane element 14, with the set of shims 64 of the reverse osmosis assembly 10 being positioned between the additional thrust collar 58 and the first end of the at least one membrane element 14.

In the first operable configuration (i.e., for reverse osmosis treatment of the feed liquid), as shown in FIG. 8, pressurized feed liquid (e.g., water) 78 is supplied to the assembly 10 through the first port 28 (i.e., the first port 28 is a feed liquid port) and passes through each RO membrane element 14, beginning with the lead element 14a proximate the first end 16 and ending with the last element 14b proximate the second end 18 of the pressure vessel 12. For example, in one embodiment, the feed liquid flow rate is preferably between 35 and 55 GPM for 8 inch RO membrane elements 14, and preferably between 30 and 50 GPM for 8 inch RO membrane elements 14. The feed pressure will depend upon the type of liquid being treated. It will be understood that the feed pressure and feed flow rate will vary depending on, for example, the dimensions of the RO membrane elements 14 and pressure vessel 12, the type and configuration of the RO membrane elements 14 and the type of feed liquid to be treated. Treated liquid or permeate passes through the membrane surface into the permeate channels of each RO membrane element 14, flows in a spiral direction toward the center of the element 14, and is ultimately collected in the core tube 38 and exits the pressure vessel 12 through the first and second permeate ports 41, 43. The concentrate (or reject) stream 80, containing the concentrated contaminants that did not pass into the permeate area, exits the assembly 10 via the second port 30.

In the second operable configuration, as shown in FIG. 9, a liquid 82 is supplied to the assembly 10 through the second port 30 and forced under pressure through each RO membrane element 14, beginning with the last element 14b proximate the second end 18 and ending with the lead element 14a proximate the first end 16 of the pressure vessel 12. The feed pressure in the reverse direction is preferably approximately 2 to 4 bar, more preferably approximately 2 to 3 bar. The flow rate of the liquid in the reverse direction is preferably approximately 67% to 100% of the flow rate of the feed water in the first operable configuration.

In a preferred embodiment, the second operable configuration is carried out for cleaning of the RO membrane assembly 10, and more particularly for removal of any accumulated foulant 84, particularly foulant accumulate at the lead RO membrane element 14a (see, e.g., FIG. 9).

For example, in one embodiment, the liquid 80 supplied to the pressure vessel 12 via the second port 30 is a cleaning solution or a flushing solution (i.e., the second port 30 is a cleaning/flushing solution port), which is first introduced through the last RO membrane element 14b and then pumped through all of the RO membrane elements 14 toward the lead RO membrane element 14a. The cleaning solution breaks up the foulant 84 accumulated on the RO membrane elements 14 and carries the foulant 84 out of the pressure vessel 12 in a waste stream 86 via the first port 28 (i.e., the first port is a waste solution port). The combination of the first thrust collar 58, the first set of shims 62 and the second set of shims 64 support and minimize rearward movement, extension or telescoping of the RO membrane elements 14 during the cleaning operation.

It will be understood that any known commercially available cleaning solution or flushing solution may be used for cleaning of the RO membrane assembly 10. Preferably, the cleaning solution or flushing solution is selected based on the type of foulant (i.e., the solution which is known to be most suited for removal of the accumulated foulant is utilized). Examples of some suitable solutions include, but are not limited to, sodium tripolyphosphate, sodium EDTA, sodium dodecylbenzene sulfonate (DDBS), sodium lauryl sulfate, sodium hydroxide, and citric acid. It will also be understood that multiple cleaning cycles utilizing the same or different cleaning/flushing solutions may be carried out in the reverse flow direction.

In another embodiment of the second operable configuration, the liquid 82 for cleaning of the RO membrane assembly 10 may be clean water or RO permeate, and the assembly 10 operates under the same conditions as RO membrane cleaning (e.g., pressure of 2 to 3 bar) in a reverse flow direction. That is, the clean water or permeate is supplied to the assembly 10 through the second port 30 (i.e., the second port 30 is a feed port) and passes through each RO membrane element 14, beginning with the last RO membrane element 14b proximate the second end 18 and ending with the lead RO membrane element 14a proximate the first end 16 of the pressure vessel 12, and the concentrate containing the concentrated contaminants that did not pass through the RO membrane elements 14 exits the assembly 10 via the first port 28 (i.e., the first port 28 is a concentrate port).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An assembly for treating a liquid, the assembly comprising:
one or more pressure vessels, each pressure vessel having a first end provided with a first endcap, an opposing second end provided with a second endcap, and a sidewall extending between the first and second ends;
at least one membrane element positioned within each pressure vessel between the first and second ends, each membrane element having a first end and an opposing second end;
a first adapter coupling the first endcap of each pressure vessel with the first end of the at least one membrane element;
a first set of shims positioned between a distal end of the first endcap of each pressure vessel and the respective first adapter;
a first thrust collar positioned between the first endcap of each pressure vessel and the first end of the at least one membrane element, the first thrust collar having a first open end, an opposing second open end and a sidewall extending from the first open end to the second open end, the second open end abutting the first endcap;
a second thrust collar positioned between the second endcap of each pressure vessel and the second end of the at least one membrane element, the second thrust collar having a first open end, an opposing second open end and a sidewall from the first open end to the second open end, the second open end abutting the second endcap; and
a second set of shims positioned between the first open end of the first thrust collar and the first end of the at least one membrane element, an overall thickness of the second set of shims being the same as an overall thickness of the first set of shims.

2. The assembly according to claim 1, wherein the assembly is a reverse osmosis assembly.

3. The assembly according to claim 2, comprising a series of interconnected membrane elements positioned within the pressure vessel(s) between the first and second ends, a first membrane element in the series being positioned proximate the first end of the pressure vessel and a last membrane element in the series being positioned proximate the second end of the pressure vessel,
wherein the first adapter couples the first endcap with the first membrane element.

4. The assembly according to claim 3, wherein the first endcap includes a first permeate port in flow communication with the first membrane element and the second endcap includes a second permeate port in flow communication with the last membrane element.

5. The assembly according to claim 4, wherein a second adapter couples the second endcap with the last membrane element.

6. The assembly according to claim 2, wherein the sidewall of the first thrust collar tapers from the first open end thereof to the second open end thereof.

7. The assembly according to claim 2, wherein the sidewall of the second thrust collar tapers from the first open end thereof to the second open end thereof.

8. The assembly according to claim 2, wherein the at least one membrane element is a spiral wound membrane element.

9. The assembly according to claim 2, wherein the first endcap includes a first permeate port in flow communication with the first end of the at least one membrane element and the second endcap includes a second permeate port in flow communication with the second end of the at least one membrane element.

10. A kit for a reverse osmosis assembly, the reverse osmosis assembly comprising a pressure vessel having a first end provided with a first endcap and an opposing second end provided with a second endcap, at least one membrane element positioned within the pressure vessel between the first and second ends, a first adapter coupling the first endcap with a first end of the at least one membrane element, a thrust collar positioned between the second endcap and a second end of the at least one membrane element, and a set of shims positioned between the first endcap and the first end of the at least one membrane element, the kit comprising:
an additional set of shims configured to be positioned between a distal end of the first endcap and the first adapter of the reverse osmosis assembly, the additional set of shims having an overall thickness preselected to be the same as an overall thickness of the set of shims of the reverse osmosis assembly; and
an additional thrust collar configured to be positioned between the first endcap and the first end of the at least one membrane element of the reverse osmosis assembly, the set of shims of the reverse osmosis assembly being positioned between the additional thrust collar and the first end of the at least one membrane element.

11. The kit according to claim 10,
wherein the reverse osmosis assembly comprises a series of interconnected membrane elements positioned within the pressure vessel between the first and second ends, a first membrane element in the series being positioned proximate the first end of the pressure vessel and a last membrane element in the series being positioned proximate the second end of the pressure vessel; and
wherein the additional thrust collar is configured to be positioned between the first endcap and a first end of the first membrane element of the reverse osmosis assembly.

12. The kit according to claim 10, wherein the additional thrust collar has a first end, an opposing second end and a sidewall extending from the first end to the second end.

13. The kit according to claim 12, wherein the sidewall of the additional thrust collar tapers from the first end thereof toward the second end thereof.

14. The kit according to claim 12, wherein a diameter of the first end of the additional thrust collar is the same as a diameter of the second end of the additional thrust collar.

15. The kit according to claim 10, wherein each shim of the additional set of shims has a generally hollow cylindrical shape.

16. A method of operating a reverse osmosis assembly comprising a pressure vessel having a first end provided with a first endcap and an opposing second end provided with a second endcap, a first port proximate the first end of the pressure vessel and a second port proximate the second end of the pressure vessel, at least one membrane element positioned within the pressure vessel between the first and second ends, a first adapter coupling the first endcap with a first end of the at least one membrane element, a first thrust collar positioned between the first endcap and the first end of the at least one membrane element, a second thrust collar positioned between the second endcap and a second end of the at least one membrane element, a first set of shims positioned between the first thrust collar and the first end of the at least one membrane element, and a second set of shims positioned between a distal end of the first endcap and the first adapter, an overall thickness of the second set of shims being the same as an overall thickness of the first set of shims, the method comprising:
treating a first liquid by introducing the first liquid into the pressure vessel via the first port under pressure, such that the first liquid travels through the at least one membrane element in a first direction from the first end of the at least one membrane element toward the second end of the at least one membrane element; and
upon detection of foulant accumulated on the at least one membrane element, cleaning the assembly by introducing a second liquid into the pressure vessel via the second port, such that the second liquid travels through the at least one membrane element in a second direction from the second end of the at least one membrane element toward the first end of the at least one membrane element.

17. The method according to claim 16, wherein the second liquid is selected from the group consisting of a cleaning solution, water and permeate.

18. The method according to claim 16, wherein the reverse osmosis assembly comprises a series of interconnected membrane elements positioned within the pressure vessel between the first and second ends, a first membrane element of the series being positioned proximate the first end and a last membrane element of the series being positioned proximate the second end,
wherein the first liquid travels through the series of interconnected membrane elements in the first direction from the first membrane element toward the last membrane element; and
wherein the second liquid travels through the series of interconnected membrane elements in the second direction from the last membrane element toward the first membrane element.

19. The method according to claim 16, wherein a flow rate of the second liquid traveling in the second direction is approximately 67% to 100% of a flow rate of the first liquid traveling in the first direction.
